(19) United States
(12) Patent Application Publication
(10) Pub. No.: US 2004/0075879 A1
(43) Pub. Date: Apr. 22, 2004

(54) Multiple scanning system and method

(75) Inventor: Jacob Karin, Ramat Gan (IL)

Correspondence Address: DR. MARK FRIEDMAN LTD., C/O BILL POLKINGHORN, DISCOVERY DISPATCH, 9003 FLORIN WAY, UPPER MARLBORO, MD, 20772, US

(73) Assignee: Accretech (Israel) Ltd.

(21) Appl. No.: 10/618,766

(22) Filed: Jul. 15, 2003

Related U.S. Application Data
(63) Continuation-in-part of application No. 10/156,143, filed on May 29, 2002.
(63) Continuation-in-part of application No. 10/159,042, filed on Jun. 3, 2002, now Pat. No. 6,603,589.

(51) Int. Cl. G02B 26/08

(52) U.S. Cl. 359/212

(57) ABSTRACT

A scanning system for scanning the surface of a sample. The system includes a scanning head, a mounting arrangement configured for mounting the sample thereon, a drive mechanism configured for providing relative motion between the scanning head and the mounting arrangement, an optical system and an adjustment mechanism. At least part of the optical system is included in the scanning head. The optical system is configured for simultaneously reading from at least two non-overlapping viewing regions of the surface. The adjustment mechanism is configured for adjusting at least part of the optical system so as to vary a spacing of the at least two non-overlapping viewing regions read by the optical system.

This application is a Continuation-in-part of U.S. application Ser. No. 10/156,143 filed 29 May 2002 and U.S. application Ser. No. 10/159,042 filed 3 Jun. 2002.

### FIELD AND BACKGROUND OF THE INVENTION

The present invention relates to a system and method for detecting defects in a periodic pattern of a sample and, in particular, it concerns a system and method for inspecting silicon wafers, masks and similar structures used in the Integrated Circuits (IC) industry.

Inspection for defects is usually based on methods of comparison. One of the popular processing methods for wafer inspection is the “two neighbors” method, in which a data set corresponding to a region of the surface under inspection is compared to data sets corresponding to two equivalent regions, typically its nearest neighbors, in order to determine which of the three regions contains a defect. This method assumes that a similar defect resulting from a manufacturing problem will not replicate itself in next neighbors.

Reference is now made to FIG. 1, which is a plan view of part of a wafer 10 being scanned by a scanner 12 that is constructed and operable in accordance with the prior art. Wafer 10 has a periodic pattern having a periodic vector p. Scanner 12 has a scanning head 14 which is configured to move relative to wafer 10 in a scan direction donated by an arrow 16. The scan direction of scanning head 14 is parallel to periodic vector p. Scanning head 14 moves in the scan direction scanning a viewing region 18, a viewing region 20 and a viewing region 22 as well as intervening regions. Viewing regions 18, 20, 22 are spaced by periodic vector p. Viewing regions 18, 20, 22 are then compared to identify if and where a defect exists. The process is repeated for the intervening regions of the pattern. Due to the accuracy required for detecting defects on a wafer, there could be one thousand or more scanning lines within a single pattern.

One of the difficulties associated with the “two neighbors” method is the consecutive nature of the data recording. Since the three data sets are not sampled at the same time, the relevant data needs to be stored and retrieved at the appropriate times. This factor in addition to the quantity of data stored at any one-time causes unnecessary computational load.

There is therefore a need for an efficient system and method for detecting defects in a periodic pattern of a sample.

### SUMMARY OF THE INVENTION

The present invention is a multiple scanner construction and method of operation thereof.

According to the teachings of the present invention there is provided, a scanning system for scanning the surface of a sample, comprising: (a) a scanning head; (b) a mounting arrangement configured for mounting the sample thereon; (c) a drive mechanism configured for providing relative motion between the scanning head and the mounting arrangement; (d) an optical system, at least part of the optical system being included in the scanning head; (e) the optical system being configured for simultaneously reading from at least two non-overlapping viewing regions of the surface; and (f) an adjustment mechanism configured for adjusting at least part of the optical system so as to vary a spacing of the at least two non-overlapping viewing regions read by the optical system.

According to a further feature of the present invention, the scanning head includes at least two objective lenses, each of the at least two objective lenses being uniquely associated with one of the at least two non-overlapping viewing regions; and the adjustment mechanism is configured so as to vary the spacing of the at least two objective lenses.

According to a further feature of the present invention, the optical system is configured for simultaneously reading from at least three non-overlapping viewing regions of the surface.

According to a further feature of the present invention, the adjustment mechanism is configured to maintain substantially equal spacing among the at least three non-overlapping viewing regions.

According to the teachings of the present invention there is also provided a method for scanning a surface of a sample using a scanning system, the scanning system having a scanning head configured to perform a scanning motion relative to the surface, the scanning system having an optical system, at least part of the optical system being included in the scanning head, the optical system being configured for simultaneously reading from a plurality of non-overlapping viewing regions of the surface, the method comprising the steps of: (a) adjusting at least part of the optical system so as to vary a spacing of the non-overlapping viewing regions read by the optical system; and (b) providing relative movement between the scanning head and the surface.

According to a further feature of the present invention, there is also provided the step of simultaneously reading from at least three of the non-overlapping viewing regions of the surface.

According to a further feature of the present invention, the step of adjusting is performed by adjusting at least part of the optical system so as to vary a spacing of at least three of the non-overlapping viewing regions read by the optical system such that the non-overlapping viewing regions are substantially equally spaced.

According to the teachings of the present invention there is also provided a method for scanning a surface having a periodic pattern, the periodic pattern having a vector of periodicity, the method comprising the steps of: (a) simultaneously reading from a first viewing region of the surface and a second viewing region of the surface so as to generate a first image of at least part of the first viewing region and a second image of at least part of the second viewing region, the first viewing region and the second viewing region being spaced substantially by a first integer multiple of the vector of periodicity, an area of the first viewing region being a minority of an area of the pattern, an area of the second viewing region being a minority of the area of the pattern; (b) and comparing at least part of the first image and at least part of the second image.

According to a further feature of the present invention: (a) the step of simultaneously reading is performed by simultaneously reading from the first viewing region of the surface, the second viewing region of the surface and a third viewing region of the surface so as to generate the first image, the second image and a third image of at least part of the third viewing region; (b) the second viewing region and the third viewing region being spaced substantially by a second integer multiple of the vector of periodicity; (c) an area of the third viewing region being a minority of an area of the pattern.

According to the teachings of the present invention there is also provided a method for scanning a surface of a sample using a scanning system, the surface having a periodic pattern, the periodic pattern having a first vector of periodicity, the scanning system having a scanning head configured to perform a scanning motion relative to the surface, the scanning system having an optical system, at least part of the optical system being included in the scanning head, the optical system being configured for simultaneously reading from a plurality of non-overlapping viewing regions of the surface, the non-overlapping viewing regions being spaced by a translation vector, the method comprising the steps of: (a) positioning the optical arrangement and the sample in relation to each other, such that, the translation vector is aligned substantially parallel to the first vector of periodicity; (b) adjusting the optical arrangement, such that, a length of the translation vector is substantially equal to an integer multiple of a length of the vector of periodicity; (c) simultaneously reading from the first viewing region and the second viewing region; (d) comparing at least part of a first image of at least part of the first viewing region and at least part of a second image of at least part of the second viewing region; (e) and providing relative movement between the scanning head and the surface in a direction which is substantially perpendicular to the first direction of periodicity.

According to a further feature of the present invention, the step of simultaneously reading is performed by simultaneously reading from the first viewing region, the second viewing region and a third viewing region of the surface.

### BRIEF DESCRIPTION OF THE DRAWINGS

The invention is herein described, by way of example only, with reference to the accompanying drawings, wherein:

FIG. 1 is a plan view of part of a wafer being scanned by a scanner that is constructed and operable in accordance with the prior art;

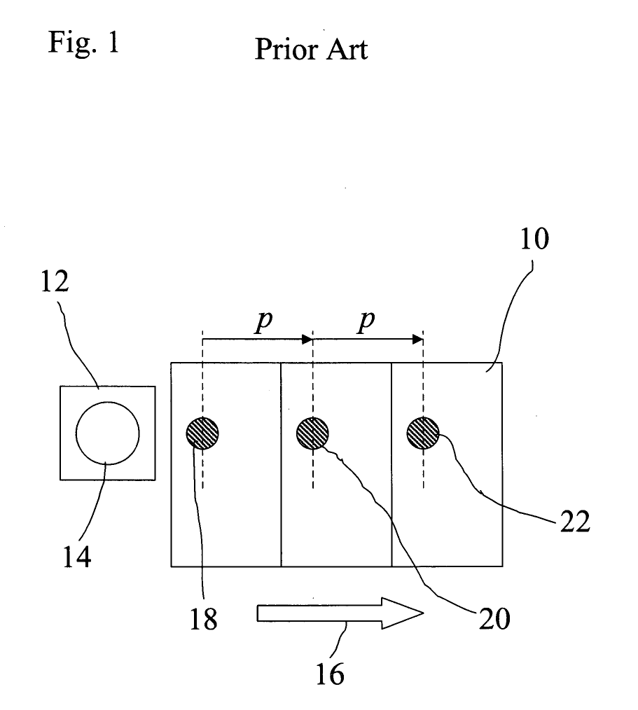

FIG. 2 is a schematic side view of a scanner that is constructed and operable in accordance with a preferred embodiment of the invention;

FIG. 3 is a schematic plan view of the scanner of FIG. 2;

FIG. 4 is an enlarged schematic plan view of the region indicated by the letter A in FIG. 3; and

FIG. 5 is a plan view of a wafer being scanned by the scanner of FIG. 2 using a scanning method which is performed in accordance with a preferred embodiment of the invention.

### DESCRIPTION OF THE PREFERRED EMBODIMENTS

The present invention is a multiple linear scanner construction and method of operation thereof.

The principles and operation of a multiple linear scanner according to the present invention may be better understood with reference to the drawings and the accompanying description.

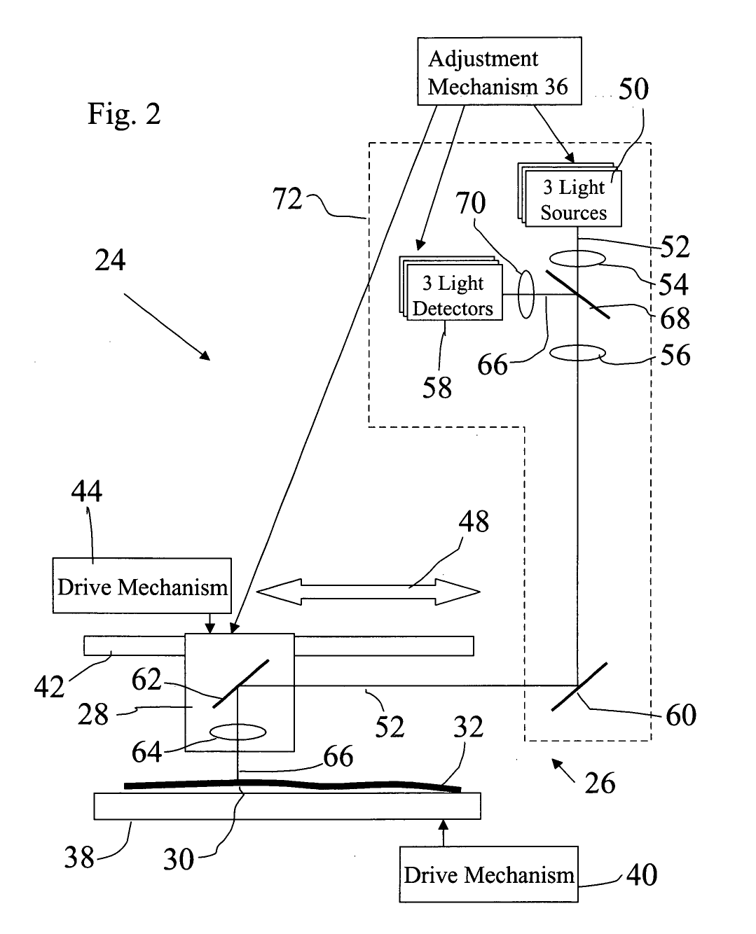

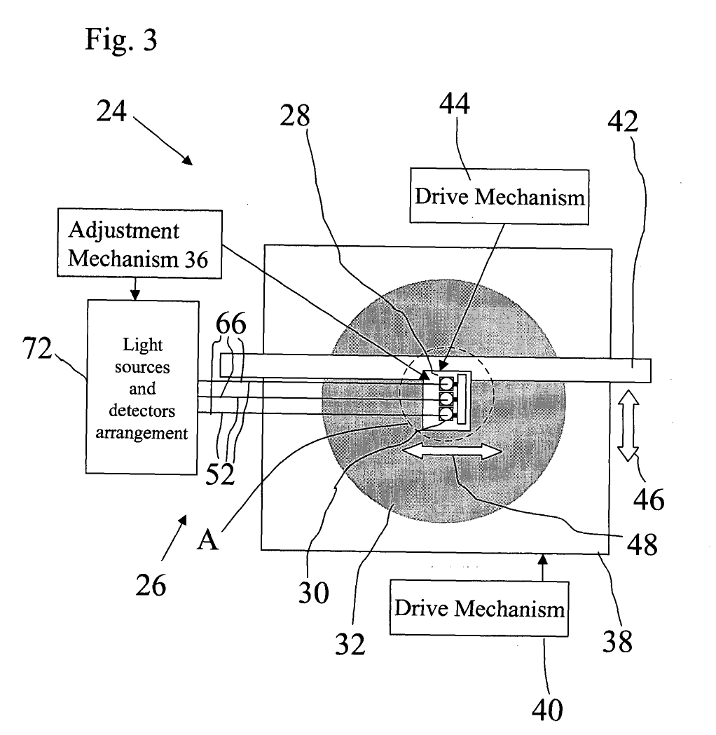

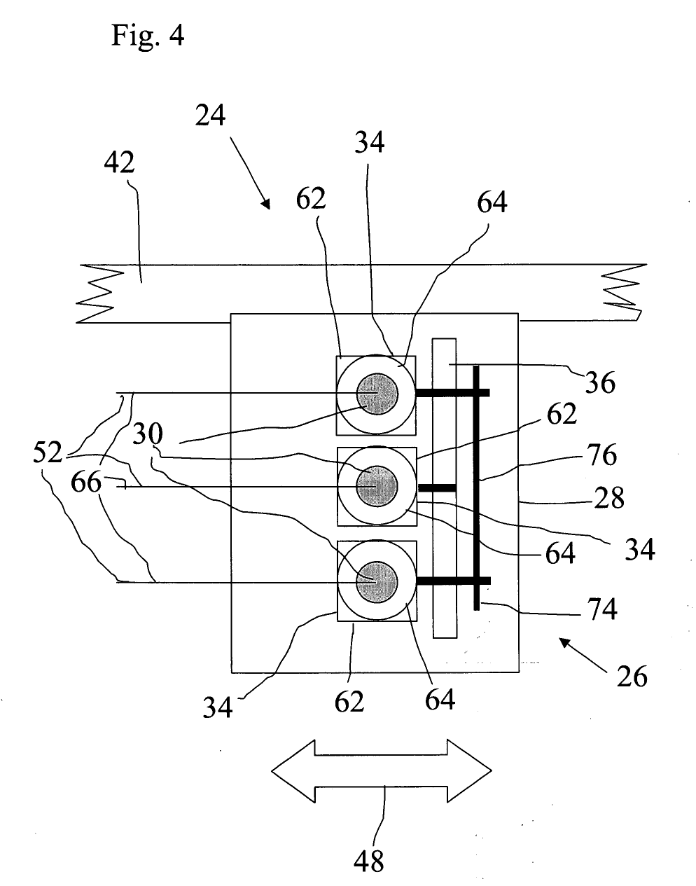

Reference is now made to FIGS. 2, 3 and 4. FIG. 2 is a schematic side view of a scanner 24 that is constructed and operable in accordance with a preferred embodiment of the invention. FIG. 3 is a schematic plan view of the scanner 24. FIG. 4 is an enlarged schematic plan view of the region indicated by the letter A in FIG. 3. Scanner 24 includes, a linear track 42, an optical system 26 and a scanning head 28. Part of optical system 26 is included in scanning head 28. Scanning head 28 is connected to linear track 42 such that scanning head 28 is moveable along linear track 42. At least one bearing (not shown), typically a fluid bearing, is disposed between scanning head 28 and linear track 42 to enable scanning head 28 to move with minimum friction along linear track 42. Scanner 24 has a mounting arrangement 38 configured for mounting a sample 32 thereon. Scanner 24 also has a drive mechanism 40 and a drive mechanism 44. Drive mechanism 40 is configured for providing relative linear motion between linear track 42 and mounting arrangement 38 in a direction, shown by an arrow 46, which is substantially perpendicular to the direction of elongation of linear track 42. However, in accordance with the most preferred embodiment of the present invention, mounting arrangement 38 is configured to move in the direction of arrow 46, while linear track 42 is configured to be stationary, thereby improving the throughput of scanner 24. Drive mechanism 44 is configured for providing relative linear motion between scanning head 28 and linear track 42 in a direction, shown by an arrow 48, which is parallel to the direction of elongation of linear track 42. Optical system 26 is configured for simultaneously reading from two or more, typically three, non-overlapping viewing regions 30 of the surface of sample 32. In other words, optical system 26 is configured to read at least part of, typically the whole of, each non-overlapping viewing region 30 at the same time and not to read non-overlapping viewing regions 30 one after the other.

Although part of optical system 26 is described as being in scanning head 28, this does not mean that optical system 26 is confined within a single housing of scanning head 28. Part of optical system 26 is described as being in scanning head 28 in that part of optical system 26 is in fixed relation with scanning head 28.

It will be appreciated by those skilled in the art that optical system 26 can incorporate confocal technology. Therefore, each non-overlapping viewing region 30 will be made up of a plurality of points created by the confocal technology.

It will also be apparent to those skilled in the art that optical system 26 can be implemented with separate or common optical components to enable simultaneous reading of non-overlapping viewing regions 30. In accordance with a most preferred embodiment of the present invention, separate optical components are used to enable simultaneous reading of non-overlapping viewing regions 30. Therefore, in accordance with this most preferred embodiment, optical system 26 includes two or more, typically three, separate optical sub-systems 34.

Each optical sub-system 34 includes a light source assembly 50 configured to produce at least one collimated beam of light 52. Typically, light source assembly 50 is configured to produce a plurality of collimated beams of light 52. It should be noted that light source assembly 50 is either a light source plus optical apparatus which is configured to produce collimated beams of light or a light source that produces collimated beams of light without the need for further optical apparatus. The optical apparatus required to produce collimated beams of light is represented in simplified form by a lens 54 and a lens 56. The production of collimated beams of light is known to those skilled in the art. Each optical sub-system 34 includes a light sensing system 58, which is typically a CCD or a TDI camera. Light source assembly 50 and light sensing system 58 are mounted in fixed spatial relation to linear track 42. Collimated beams of light 52 produced by light source assembly 50, lens 54 and lens 56 are directed towards a reflecting element 60. Reflecting element 60 is typically a mirror. Reflecting element 60 directs collimated beams of light 52 towards a reflecting system 62, which is included in scanning head 28. Reflecting system 62 is typically a single reflecting surface such as a mirror. Reflecting system 62 is configured to direct collimated beams of light 52 via an objective lens 64 onto an inspection surface of sample 32. Objective lens 64 is configured to focus collimated beams of light 52 onto the inspection surface. A plurality of beams of light 66 is reflected from the inspection surface via objective lens 64 and reflecting system 62 to reflecting element 60. Reflected beams of light 66 are directed by reflecting element 60 to a beam splitter 68. Beam splitter 68 directs beams of light 66 via a lens 70 to light sensing system 58. An optical apparatus, represented in simplified form by lens 70, is typically required to enable light sensing system 58 to receive beams of light 66, as beams of light 66 are collimated. Therefore, beam splitter 68 is configured to enable a beam of light being transmitted by light source assembly 50 and a beam of light being received by light sensing system 58 to share substantially a same path between the inspection surface and beam splitter 68. Beam splitter 68 is typically a polarizing beam splitter. The technology to produce beam splitter 68 is known by those skilled in the art and in order to make beam splitter function, additional optical components (not shown) are needed, such as a quarter wavelength plate.

Since, collimated beams of light 52 are parallel beams of light, an optical image viewed by light sensing system 58 is unaffected by the change in distance between reflecting element 60 and scanning head 28. Therefore, scanning head 28 is moved along linear track 42 to perform a scan without compromising the quality of the optical image. Moreover, scanning head 28 is lightweight as it contains very few components. Therefore, scanning head 28 allows for fast scanning at high speed and at the same time enables fast direction reversal of scanning head 28 without soaring energy losses and mechanical noise.

Optionally, each optical sub-system 34 includes an auto-focus configuration (not shown). The auto-focus configuration is disposed in the path of reflected beams of light 66. Optionally, each optical sub-system 34 includes a confocal optical configuration (not shown), typically pinhole arrays disposed between light source assembly 50 and beam splitter 68 and between beam splitter 68 and light sensing system 58. The confocal optical configuration allows the depth of field of the image to be restricted to a very small value thus allowing viewing of a selected specific height on the sample.

The collection of light source assemblies 50, light sensing systems 58, beam splitters 68, reflecting elements 60, lenses 54, lenses 56 and lenses 70 are defined for convenience as a light source and detector assembly 72.

Therefore, scanning head 28 includes one objective lens 64 and one reflecting system 62 for each optical sub-system 34. Therefore, in the embodiment shown in FIGS. 2, 3 and 4, scanning head 28 includes three objective lenses 64 as well as three reflecting systems 62. Each of the three objective lenses 64 is uniquely associated with one of non-overlapping viewing regions 30.

Scanner 24 also includes an adjustment mechanism 36 which is configured for adjusting optical system 26 so as to vary the spacing of non-overlapping viewing regions 30 read by optical system 26. Therefore, adjustment mechanism 36 is typically configured to vary the spacing of objective lenses 64, reflecting systems 62 as well as other optical components of light source and detector assembly 72, as necessary. Additionally, adjustment mechanism 36 is configured to maintain substantially equal spacing among non-overlapping viewing regions 30. Adjustment mechanism 36 is described as being configured to maintain “substantially” equal spacing as the accuracy of the spacing among non-overlapping viewing regions 30 is typically a user defined requirement depending upon the scanning accuracy needed. Adjustment mechanism 36 typically includes a mechanical arrangement 74 having a plurality of high precision screw threads or linear motors 76 for adjusting the spacing of non-overlapping viewing regions 30. Optionally, the components of optical system 26 are slidably mounted such that the components of optical system 26 are moved as necessary using a motorized means (not shown) to adjust the spacing of non-overlapping viewing regions 30. For example, the spacing of reflecting systems 62 and objective lenses 64 is adjusted by a motorized system (not shown) which is disposed at one end of linear track 42 when scanning head 28 is at that end of linear track 42.

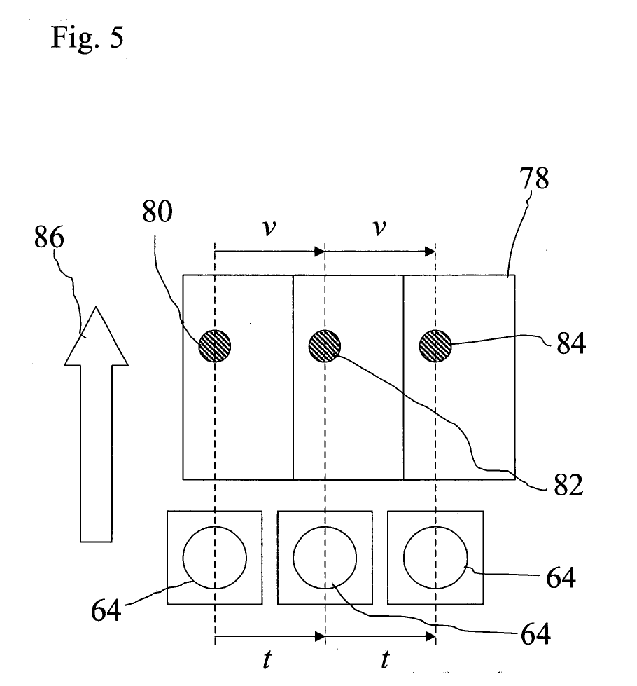

Reference is now made to FIG. 5, which is a plan view of a wafer 78 being scanned by scanner 24 using a scanning method which is performed in accordance with a preferred embodiment of the invention. As discussed above, one of the difficulties associated with the prior art “two neighbors” method is the consecutive nature of the data recording. Since in accordance with the prior art the three data sets are not sampled at the same time, the relevant data needs to be stored and retrieved at the appropriate times. This factor in addition to the quantity of data stored at any one-time causes unnecessary computational load. Therefore, the present invention teaches a method for scanning a surface having a periodic pattern, such that, relevant comparable data sets are scanned at the same time. The periodic pattern has a vector of periodicity, v. The method includes the following general steps. Scanner 24 is configured, such that, a viewing region 80 of the surface of wafer 78, a viewing region 82 of the surface of wafer 78 and a viewing region 84 of the surface of wafer 78 are simultaneously read so as to generate a first image of at least part of, typically the whole of, viewing region 80, a second image of at least part of, typically the whole of, viewing region 82 and a third image of at least part of, typically the whole of, viewing region 84. Viewing region 80 and viewing region 82 are spaced substantially by a first integer multiple of the vector of periodicity, v. Similarly, viewing region 82 and viewing region 84 are spaced substantially by a second integer multiple of the vector of periodicity, v. Generally, the spacing between viewing regions 80, 82, 84 is substantially equal. In other words, the first integer and second integer are generally equal. Viewing regions 80, 82, 84 are described as being “substantially” spaced by an integer multiple of the vector of periodicity, v in that the accuracy of the spacing of viewing region 80, 82, 84 depends on the accuracy of the comparison needed and is therefore decided by the operator of scanner 24. The area of viewing region 80 is a minority of the area of the pattern. Also, the area of viewing region 82 is a minority of the area of the pattern. Similarly, the area of viewing region 84 is a minority of the area of the pattern. Second, at least part of the first image, at least part of the second image and at least part of the third image are compared to identify if a defect exists and the location of a possible defect. It will be appreciated by those skilled in the art that the above method can also be performed for two or more viewing regions.

It will be appreciated by those skilled in the art that a scanner configured to read simultaneously two or more corresponding, but non-overlapping, viewing regions is generally needed to perform the above method. Moreover, the scanner needs to be configured, such that, the spacing between the non-overlapping viewing regions is adjustable in order for the spacing of the non-overlapping viewing regions to match an integer multiple of the periodic vector of the pattern being inspected. Therefore, the above method is best performed using scanner 24. In accordance with a most preferred embodiment of the present invention, the spacing of the non-overlapping viewing regions read by scanner 24 is substantially equal. Therefore, the spacing of the non-overlapping viewing regions can be described as being spaced by a translation vector, t. As the non-overlapping viewing regions are approximately the same size and shape, translation vector, t, is defined as a vector connecting same points of the non-overlapping viewing regions. The general scanning method, described above, is now described in more detail below incorporating steps referring to scanner 24. First, optical system 26 of scanner 24 and wafer 78 are positioned in relation to each other, such that, translation vector, t, is aligned substantially parallel to vector of periodicity, v. Second, optical system 26 is adjusted using adjustment mechanism 36, such that, the length of translation vector, t, is substantially equal to an integer multiple of the length of the vector of periodicity, v. Translation vector, t, is described as being adjusted to be “substantially” equal to an integer multiple of vector of periodicity, v, in that the accuracy of the spacing of translation vector, t, and therefore viewing region 80, 82, 84 depends on the accuracy of the comparison needed and is therefore decided by the operator of scanner 24. Now, the centers of objective lenses 64 are approximately separated by translation vector, t. Third, relative movement between scanning head 28 and the surface of wafer 78 is provided in a direction, shown by an arrow 86, which is substantially perpendicular to vector of periodicity, v. Scanner 24 then simultaneously reads from viewing region 80, viewing region 82 and viewing region 84. Fourth, generating a first image of at least part of, typically the whole of, viewing region 80, a second image of at least part of, typically the whole of, viewing region 82 and a third image of at least part of, typically the whole of, viewing region 84. Finally, comparing at least part of the first image, at least part of the second image and at least part of the third image to identify if a defect exists and the location of a possible defect.

It will be appreciated by those skilled in the art that scanner of the present invention enables the implementation of multiple light sources and detectors within a single scanner. This option is especially important in systems implementing DUV CW laser light sources having limited intensity, and for high-speed image sensors that are limited by data channeling problems. It will also be appreciated by those skilled in the art the triple scanner described above can also be implemented to read two or more non-overlapping viewing regions.

It will be appreciated by persons skilled in the art that the present invention is not limited to what has been particularly shown and described hereinabove. Rather, the scope of the present invention includes both combinations and sub-combinations of the various features described hereinabove, as well as variations and modifications thereof that are not in the prior art which would occur to persons skilled in the art upon reading the foregoing description.

What is claimed is:

1. A scanning system for scanning the surface of a sample, comprising:
(a) a scanning head;
(b) a mounting arrangement configured for mounting the sample thereon;
(c) a drive mechanism configured for providing relative motion between said scanning head and said mounting arrangement;
(d) an optical system, at least part of said optical system being included in said scanning head; said optical system being configured for simultaneously reading from at least two non-overlapping viewing regions of the surface; and
(e) an adjustment mechanism configured for adjusting at least part of the optical system so as to vary a spacing of said at least two non-overlapping viewing regions read by said optical system.

2. The system of claim 1 wherein:
(a) said scanning head includes at least two objective lenses, each of said at least two objective lenses being uniquely associated with one of said at least two non-overlapping viewing regions; and
(b) said adjustment mechanism is configured so as to vary the spacing of said at least two objective lenses.

3. The system of claim 1 wherein said optical system is configured for simultaneously reading from at least three non-overlapping viewing regions of the surface.

4. The system of claim 3 wherein said adjustment mechanism is configured to maintain substantially equal spacing among said at least three non-overlapping viewing regions.

5. A method for scanning a surface of a sample using a scanning system, the scanning system having a scanning head configured to perform a scanning motion relative to the surface, the scanning system having an optical system, at least part of the optical system being included in the scanning head, the optical system being configured for simultaneously reading from a plurality of non-overlapping viewing regions of the surface, the method comprising the steps of:
(a) adjusting at least part of the optical system so as to vary a spacing of the non-overlapping viewing regions read by the optical system; and
(b) providing relative movement between the scanning head and the surface.

6. The method of claim 5, further comprising the step of simultaneously reading from at least three of the non-overlapping viewing regions of the surface.

7. The method of claim 5 wherein said step of adjusting is performed by adjusting at least part of the optical system so as to vary a spacing of at least three of the non-overlapping viewing regions read by the optical system such that said non-overlapping viewing regions are substantially equally spaced.

8. A method for scanning a surface having a periodic pattern, the periodic pattern having a vector of periodicity, the method comprising the steps of:
(a) simultaneously reading from a first viewing region of the surface and a second viewing region of the surface so as to generate a first image of at least part of said first viewing region and a second image of at least part of said second viewing region, said first viewing region and said second viewing region being spaced substantially by a first integer multiple of said vector of periodicity, an area of said first viewing region being a minority of an area of the pattern, an area of said second viewing region being a minority of said area of the pattern; and
(b) comparing at least part of said first image and at least part of said second image.

9. The method of claim 8, wherein:
(a) said step of simultaneously reading is performed by simultaneously reading from said first viewing region of the surface, said second viewing region of the surface and a third viewing region of the surface so as to generate said first image, said second image and a third image of at least part of said third viewing region;
(b) said second viewing region and said third viewing region being spaced substantially by a second integer multiple of said vector of periodicity;
(c) an area of said third viewing region being a minority of an area of the pattern.

10. A method for scanning a surface of a sample using a scanning system, the surface having a periodic pattern, the periodic pattern having a first vector of periodicity, the scanning system having a scanning head configured to perform a scanning motion relative to the surface, the scanning system having an optical system, at least part of the optical system being included in the scanning head, the optical system being configured for simultaneously reading from a plurality of non-overlapping viewing regions of the surface, said non-overlapping viewing regions being spaced by a translation vector, the method comprising the steps of:
(a) positioning the optical arrangement and the sample in relation to each other, such that, the translation vector is aligned substantially parallel to the first vector of periodicity;
(b) adjusting the optical arrangement, such that, a length of the translation vector is substantially equal to an integer multiple of a length of the vector of periodicity;
(c) simultaneously reading from the first viewing region and the second viewing region;
(d) comparing at least part of a first image of at least part of the first viewing region and at least part of a second image of at least part of the second viewing region; and
(e) providing relative movement between the scanning head and the surface in a direction which is substantially perpendicular to the first direction of periodicity.

11. The method of claim 10, wherein said step of simultaneously reading is preformed by simultaneously reading from said first viewing region, said second viewing region and a third viewing region of the surface.
